(19) United States
(12) Patent Application Publication
(10) Pub. No.: US 2015/0134129 A1
(43) Pub. Date: May 14, 2015

(54) CONTINUOUSLY CALIBRATING CHEMIGATION INJECTION UNIT

(71) Applicant: SYNGENTA PARTICIPATIONS AG, Basel (CH)

(72) Inventor: Daniel Warden Kidder, Greensboro, NC (US)

(73) Assignee: SYNGENTA PARTICIPATIONS AG, Basel (CH)

(21) Appl. No.: 14/400,344

(22) PCT Filed: May 17, 2013
(86) PCT No.: PCT/US13/41533

§ 371 Date: Nov. 11, 2014

Related U.S. Application Data
(60) Provisional application No. 61/651,074, filed on May 24, 2012.

(51) Int. Cl. A01G 25/16; G05B 15/02; A01C 23/00

(52) U.S. Cl. CPC A01G 25/16; A01C 23/007; G05B 15/02
USPC 700/284

(57) ABSTRACT

This invention relates to a method and means to control an irrigation system and an apparatus for chemical input. A chemical injection apparatus interfaces with the irrigation system in an automated way to control the application of fertilizers, nutrients, pesticides, plant growth regulators and modifying agents, water conditioners, soil conditioners and additives, and water. More particularly this invention teaches a method and device for remotely operating a continuously-calibrating chemical dispensing device of a chemigation unit, and the equipment associated with data acquisition, control and injection equipment.

Agricultural irrigation systems and their components are employed to irrigate crops. A typical mechanized irrigation system is a pivot system. This type of irrigation provides a high pressure delivery system that often includes a center pivot that communicates with the water supply; while it traverses the field with a transport drive which is electrical, hydraulic, or water pressure driven. The center pivot system has a number of metal frames or transports that traverse the field above the plant canopy. These transports support a conduit for carrying liquids. The center pivot system has a series of sprayers, nozzles, drop nozzles, sprinkler heads, or other fluid emitting devices in fluid engagement with the conduit. Typically, these moving transports carry these conduits and releases fluid from the nozzles across the growing area. The amount of water applied to any particular growing area is usually determined by the travel speed and the rate of the water being released. Pivot systems operational capacity can range from 1 acre up to 500 acres or more.

Chemigation systems typically provide a way to introduce fertilizer and/or other desirable chemicals into the irrigation system to reduce cost and carbon footprint. Additionally, some products are more effective when applied in irrigation water as opposed to conventional spray equipment. One system concern is the management and control of the various valves, pumps, sensors, or devices that provide the desired amount of chemical, at the desired rate and time, into the irrigation system. For example, state-of-the-art chemical injection devices, presently require a calibration step. Traditionally, the pumps, the sensors, the devices, the valves, utilized within the irrigation system require a manual calibration step. The irrigation system needs manual calibration, because the equipment injects chemicals at varying rates depending on the desired chemical rate per unit area, chemical viscosity, the speed at which the irrigation boom travels, and the pressure of the water line. Calibrating is required for the safe and accurate operation of the chemical injection into the irrigation system. Unfortunately, calibration of the equipment is a time consuming process which is not consistently, accurately calculated. The need to calibrate makes the chemical irrigation system complex, and results in inconsistent application rates of the desired compositions on the growing area.

The existing chemical injection devices that have been developed to automatically inject pesticides or other chemical additives into an irrigation system typically require the user to set the chemical injector pump speed to match the desired rate of chemical application and the intended speed of the traveling irrigation boom. This is accomplished with the use of manufacturer supplied tables which provide approximate injector speed settings. These tables do not take into account differences in viscosity of the various chemicals typically used and differences in actual water pressure and actual vs desired speed of the irrigation boom travel. Therefore, the user must make a test application of the product on a few acres while measuring the chemical outflow over a specific period of time to determine if the settings are correct. Typically the application is not correct on the first try so settings are adjusted and the test procedure is repeated until the appropriate application rate is achieved. Unfortunately, the application of chemical to the test area may be greater or less than the desired rate of application and cannot be subsequently corrected in practice. Any changes the user chooses to make to the equipment within or between applications will require a new recalibration procedure. Typical examples of change include, a new desired chemical application rate or irrigation water application rate. Some changes can happen without the awareness of the user, for example if water level in the well drops during the application there will be a corresponding reduction in the traveling boom speed in automated systems which causes an unintended increase in the chemical application rate per acre. Similarly, if the power drive system slows down on uphill grades and speeds up on downhill grades the true application rate of chemical per treated acre will change. Thus, proper calibration typically requires the user to expend, time, effort and significant attention to detail to avoid mistakes in the chemical application. Incorrect chemical application can result in injury to the operator, the environment, or the plants within the growing area. The existing devices have no mechanism for alerting the user of mistakes or concerns, other than to rely on the user to notice there is too much or too little chemical remaining in the source tank after an application or to notice lack of efficacy or crop injury post application. There is a need for an irrigation system that provides more efficient chemical application, is less time intensive, more user friendly, and that is able to provide the introduction of chemicals into irrigation systems without the need to be manually calibrated. There is a need to operate a chemigation system by inputting the chemical rate in product/area and have the injection equipment continuously inject it into the water line with automatic compensation for fluctuations in irrigation device speed.

### SUMMARY

The chemigation embodiment automates the injection pump so the apparatus does not require manual calibration of the equipment. This system, without the manual calibration step, is possible because the chemical injection is not based on fixed settings for application variables. In fact, this embodiment of the equipment works to automate the calibration of the system so that it is consistently accurate in real time; providing accurate chemical dosage on the irrigated area. This embodiment eliminates errors due to user's attempted calibration of the equipment and automatically compensates for real time intended and unintended changes in the system for example, changes in travel speed, water pressure, chemical dosage rates. The embodiment has failsafe logic and control equipment which will shut down the chemical injection pump and switch the device off in emergency situations thus reducing the likelihood of injury to the operator or the environment. This invention can also warn the operator of attempted misapplication of chemicals. This embodiment will monitor the chemigation progress, warn of low chemical quantities, and shut down the chemical pump at the end of an irrigation cycle or earlier if the intended application cannot be maintained by the equipment.

An embodiment is a system and method for wireless chemical irrigation utilizing a centralized control server with a database that gathers the data from the sensors and has input data on such things as soil type, field topography, temperature, weather, moisture, night time heat, day length and the like. This irrigation system is configured so that control of the entire system can be accomplished remotely.

The controller is easy to retrofit on existing irrigation or chemigation systems and can be operated at the irrigation site manually, or offsite remotely through computer, website, mobile phone, cable, or land line. In the irrigation system the controller is for gathering the system input and output data, and the GPS locations of the transports. Specifically, this controller receives input and output data from the chemical dispensing device that allows it to continuously calibrate this system. This chemical dispensing device is easily installed in an existing irrigation system which may or may not have chemical irrigation abilities. The controller and hardware for activating the chemical dispensing device also can be easily installed on existing chemical dispensing devices or can be installed with the installation of a different dispensing device.

### BRIEF DESCRIPTION OF THE DRAWINGS

FIG. 1 shows a controller system with input sensor and output capabilities, chemical dispensing system, and a water supply irrigation system, chemical dispensing device, according to one embodiment.

Most chemigation systems require a labor intensive calibration step; there may be some chemigation systems that attempt to provide a self-calibrating system. Principally employing expected travel speeds of the transport and/or expected flow rates in an attempt to calibrate the amount of chemical being applied to the overall growing area. This type of calibration step provides an average calibration for the system. It does not provide for actual chemigation systems which have transport speed increases and/or decreases due to a number of factors including mechanical issues, weather, and land contours, etc. The present embodiments eliminate the need for these calibration steps, with a method that improves the overall efficiencies of the chemigation system, through substantially more accurate application of chemical product which in turn increases environmental safety and product efficacy. The system in these embodiments use a real time, continuously calibrating system which avoids a manual or self-calibrating step and provides actual real time chemical requirements as needed to the growing area.

This system has three primary components: the water supply device 11, the chemical device system 100, and the controller system 130. The water device 11 is formed of the irrigation device 90, the water supply inlet lines 22 and outlet lines 30, their associated backflow preventers, the water pump 25, the water flow meter 37, the water source 118 and the water. The chemical dispensing device 100 is formed of the chemical source 60, the inlet line 62, the pump 45, the controlled pump motor 58, the chemical outlet line 40, the chemical flow meter 47 and the back flow preventer 44, and the conjunction of the water supply outlet line 30 and the transition point 38 and, optionally, the inline mixer 39. The controller system 130 is formed of data signals 170 from at least the following: the wireless inputs 171 from the web, radio, computer, or cellular device, the water flow meter signal 77, the chemical flow meter 87, the chemical tank signal 67 and the location GPS device signal 97, the panel 70 and input signals from the panel 72, the wireless inputs signals 174, which include GPS signal 97 and wireless inputs 171, the controller 17 with computing capability, processing of inputs, real time reporting and output actuation signal 59, and operatively linked hardware to actuate values and pumps and motors, such as motor 58, for dispensing chemicals and, optionally, for operating the water pump 25. These three systems 130, 100 and 11 operate together in the embodied system to provide remote chemigation which is continuously calibrating to provide appropriate chemical dosages to the growing areas.

### Controller System

The purpose of the controller 17, other than controlling the basic irrigation processes, with this remote control operation ability is to make direct injection of pesticides and other agricultural chemicals into irrigation equipment simple and accurate for users. An exemplary embodiment has a controller 17, with at least one of the following: receiver, power source, processor, reporting device to transmit data and graphics, reports and the like.

### Receiver

This system comprises a controller device with a data input receiver to receive wired or wireless data inputs. These inputs can include web, radio or cellular user input and reporting. These can also include inputs from various data sources: background input which may provide soil type, elevation, ground contouring and the like, irrigation devices which may provide status (irrigation cycle on or off), weather stations which may provide evaporation, water deficiencies, soil stations which may provide soil moisture and the like. The controller may also have a physical panel 70 for data input such as programming and control of the chemigation system. The data input receiver is one function of the controller.

### Power Source

The controller system 17 has a power source which can use battery, electric, light, wind or water powered for operation of the devices associated with the controller system 130.

### Processor

The controller 17 functions as a processor include computing capabilities, operation of programmed equations, and algorithms to process input and generate signals to actuate hardware based on the results of the processed data. The processor can have a water program for cycling water, an injection program for monitoring chemical supplies, and providing injection rates, input and output program for storing, sorting data, and/or reporting programs and the like. This controller 17 can signal the control of the injection pump 58 and/or chemical flow rate and provide real time reporting to the user. To provide accurate chemical dosages to the growing area, the computer and algorithms process inputs related to the GPS transmitter on the irrigation device, the user input which can be supplied wirelessly or manually, and the chemical flow meter. There are numerous other sensor inputs and outputs that the controller can also employ to provide accurate precise continuously calibrated chemical applications to the growing area.

### Reporting

Another function of the controller may be reporting, the memory function may record and store data inputs and outputs, status of irrigation and chemical dispensing systems, and will produce reports as text or using a graphics component to produce charts and graphs depicting the history, timing, status (complete, % completion) and dates of the actuation of the equipment, the GPS information associated with timing of the actuation, the chemical applied, and the weather conditions across activation timing, and the dosage of chemical provided to the crop, maps of where chemical was applied and which chemicals were applied and the like.

In the chemirrigation operation, the controller communicates a signal to actuate the chemigation device, valve or pump to dispense chemical into the irrigation equipment. The controller actuates this chemigation device through hardware. The actuate signal is based on the data inputs received directly or wirelessly from input sensors and output sensors processed by the controller 17.

### Controller Irrigation System

The controller receives some of these data input from the basic irrigation equipment. This equipment usually includes a fluid pump 25 connected to the water source 118 by a water supply inlet line 22. The water line 22 has a water input backflow preventer 24 located between the water pump 25 and the water source 118. The water source 118 is often a well or a line to a water supply tank or the like. The status of the water pump 25 and the water source 118 can be provided to the controller as data inputs, although this input data 69 and 218 is not necessary for operation of the chemigation automated continuously calibration system. The water line beyond the water pump 25 is the outlet line 30 which has a water flow meter 37. The meter 37 is adapted to provide data to the controller 17 on the flow rate of the fluid, and/or the water speed and/or water pump speed and the pressure of the fluid within the outlet line 30. The commercial water pumps are not based on flow rate but usually are programmed to operate at a constant preset pressure.

In one embodiment, the water supply, can be continuously adjusted by the controller system 13 based on rain deficient, temperature, evaporation, night temperatures, wind, pest/disease in crop, soil, topography, irrigation system efficiencies, crop, and crop canopy. As the software varies the water supply in light of the presentation of the input data, the parameters for the introduction of the chemical into the water line is continuously recalculated based on the new input data. The injection function within the controller 17 adjusts the pressures or fluctuates the flow rate of the chemical being introduced into the water supply. The actuation of the injection equipment is adjusted on a continuous basis to provide an accurate dosage of the chemical composition to the growing area.

### Chemical Supply System

The controller 17 utilizes the data from the meter 47 to continuously calibrate the chemical dispensing system 100 to supply the needed amount of chemical into the irrigation system 11. The chemical dispensing system has at least a chemical source 60, an injection device 45, chemical outlet line 40. In the chemical supply system 100, the chemical supply source 60 connects through chemical dispensing piping to the introduction point 38 for flow of chemical into the irrigation system 11.

The chemicals may be stored in a container in the form of granular particles, but may also be in liquid or in tablet form. Regardless, the chemical is supplied from chemical tank 60 through chemical input line 62 to the chemical injection pump 45 with its control motor 58 and valves. The injection pump 58 injects chemicals into chemical outlet line 40 passed the chemical flow meter 47 which is providing flow rate data to the controller 17. Optionally, the injection pump 45 and the controlled motor 58 can also supply data concerning status, speed, rate, temperature, etc. to the controller 17. This data is used by the controller 17 with the other input data to continuously calibrate the chemirrigation system 10. The processed information allows controller 17 to actively adjust the motor speed 58 or alter the flow rate 47 to provide appropriate chemical dosage through the system to the growing area.

The chemical in the chemical outlet line 40, when beyond the flow meter 47, flows through the back flow preventer 44 to the introduction site 38 into water outlet line 30 in a chemical fluid channel. There can be one or a multitude of introduction sites 38 located prior to the in line water mixer 39 in outlet line 30. The introduction site 38 places the chemical inlet line 40 system in fluid communication with the water outlet line 30 when the valves (not shown) for chemical flow are open. To disperse the chemical fluid from line 40 throughout the fluid in line 30 the water supply and the chemical fluid channel within the water outlet line 30 flow through the inline mixer 39. This inline mixer 39 causes the mixing of the chemical fluid channel throughout the water so that the fluid delivered through outlet line 30 to the irrigation device 90 and expelled through the nozzles is the appropriate mix of chemical and water for accurate dosage for the growing area.

The chemical dispensing device has, as indicated above, a chemical source, an injection device and chemical piping for dispensing. The chemical source 60, in the chemical dispensing system may be a chemical tank or tanks, or the actual chemical product container can be attached to the system. The injection device 45, is a pump, for example, a positive displacement pump. Positive displacement pumps have two sides, an expanding suction side and a decreasing discharge side. Expansion of the cavity on the suction side allows fluid to flow into the pump and as the cavity decreases the fluid flows out of the pump into the outlet line 40. The volume of chemical dispensed is constant thus the positive displacement pump produces substantially the same flow at a given speed (RPM) no matter the discharge pressure.

Manufacturers of irrigation chemical injection equipment have developed automatic proportional or ratio control chemical injection systems. The injection is automatically adjusted for varying water flow, typically using the data from the water flow meter 37 and the control motor 58 to make these adjustments. There are four basic types of pumps used for chemical injection. These have alternative styles of control: simple manual injection rate adjustment, proportional control where as the water flow rate varies the injection rate varies, automatic control based on timers, pH control to hold the irrigation water within a certain range, or control of a range of oxidation-reduction potential. However, the majority of agricultural chemical inputs are dosed on a per area basis, e.g. gallons or liters or pints or milliliters or ounces or grams or milligrams per acre or hectare and the like. An automated, continuously calibrating system applying product volume per unit area rates must take into account the units of area being treated per unit of time. In this embodiment chemical injection rates are continuously controlled by the real time treated area input from the GPS or other location/speed sensors.

The controller system 13 can be programmed to respond to various output data signals from the operating equipment back to the controller 17. The supply tanks 60 can be linked such that the controller 17 is provided input data on the amount of supply in these chemical tanks 60. These types of inputs can be processed and analyzed to generate a controller signal. This signal can actuate or deactivate the system itself or a switch, or specific equipment. Using this particular input data the controller 17 can automatically signal hardware to switch between a near empty tank to a full tank of chemical so dispensing of chemical by injection is a continuous automated system. Thus the chemical dispensing system 100 introduces, in a continuous system, the chemical into the irrigation pipes.

### Injection Program

The controller system 13 and particularly the injection program in the controller 17 will signal to actuate the chemical injection valve, relay, switches or pumps to dispense the chemical into the water supply.

The injection program can be programmed to continuously calibrate the system, to inject the chemicals at specific timing intervals, or at specific flow rates or for a specified time to provide accurate chemical dosage in a growing area. The output signal 59 of injection device is sent to the controller 17 for processing by the injection controller software. The system 100 may have a separate flow rate meter unit sending the controller data which is output data from this injection unit 45, or the controller may be receiving data directly from a pump unit such as a positive displacement pump, or the controller may be receiving data from a motor unit 58.

The injection software program within the controller 17 can also have chemical dispensing event timing triggered by data, such as operational status, time, weather, etc. In one exemplary embodiment, the dispensing rate of the chemical is continuously calculated based on GPS or other devices/methods of generating real travel data, with flow rate adjustments being sent to the dispensing device on a real time continuous basis for accurate chemical dosage within the growing area.

This injection program within the controller system 13 can be programmed to provide the chemical in specified patterns or locations or different rates within the growing area forming regions with different treatment regimes within one irrigation system. This allows testing areas with chemical applications formed as a patchwork, mosaic, or stripping effect to allow comparison of the chemical treated growing areas with regions with other chemicals or with other rates of chemicals and even untreated growing areas. These patterns can provide control regions without chemical treatment. The yield and agronomic data from these controls or different treatment regions can be used to calculate real cost benefit analysis of treatments.

### Irrigation Controller Program

Irrigation water is supplied to at least one water pump 25 through at least one valve 37 from water source 118 through water supply inlet line 22. The controller 17 receives input data from water supply/water pump 25 sensor when water for an irrigation cycle is moving through the pipes 22, 30. The pump 25, with its associated water valve (not shown) is selectively operated by irrigation controller program with the controller 17 of the controller system 130. The irrigation controller program may operate one or more of the pumps, relays and valves in a predetermined order to release water. The controller system 130 will monitor, store, process and report the irrigation water supply, its flow rate, its start/finish, the location of the transport relative to the growing area in real time and across time.

Likewise, the controller system 130 the injector portion of the controller 17 will monitor, store, process and report the activation of the chemical dispenser, the chemical being dispensed, its timing, flow rate, and the dosage being provided to the growing area. The chemical dispensed by the chemical introduction system into the irrigation line 30 can be fertilizer or a pesticide chemical such as an herbicide, fungicide, insecticide, etc.

The injection control system 43 is designed to activate injection in response to the input data signal from the controller 17. The controller 17 signals the activation of the injection valves and/or pump only when the chemical application is useful. To begin chemical injection into an irrigation system requires the controller to interpret what the basic parameters are in this system. The system parameter will usually include the input data from the sensors, the GPS or other location/speed information, the water pressures, supply levels pressure rates of water and chemicals, flow rates, pump status and rates, output information, status of failsafe systems and general environmental data. Environment/crop/calendar data may include the crop, age/maturity and/or disease level, day and night lengths, day and night temperatures, historical/future weather, or weather patterns, soil moisture, weather, and date and time. These system parameters will be employed by software that translates these various parameters to form a signal which will actuate control of a variety of physical components on the irrigation system to adjust water flow rates, chemical flow rates, pumps, injection systems, and the like to form a complete chemigation system. Thus the controller 17 will only activate the dispensing of chemical after its system parameters indicates at least that irrigation water is being supplied and the chemical should be dispensed.

In another embodiment the chemical can be applied without irrigation water also being released. However, this operation does require pressure adjustments within the system to insure uniform transport and distribution of the chemical on the growing area.

As part of the safety control of the system, the controller 17 can have a manual or remote shut down button, a task program and/or timer delay to delay or inactivate the injection of a chemical. The task or timer can be triggered by the water supply flow rate, or the water pump speed, a valve being activated, or by other data input. Additionally, the dispensing of the chemical can be interrupted, or delayed by the user remotely reprogramming the controller or by the controller system based on changes in input data.

When the change of water pressure or flow rate, water results in termination or reactivation of chemical dispensing activity, then the controller 17 records the termination, delay or reactivation event and sends out a report. When conditions readjust such that chemical dispensing is desireable, the controller will attempt to reactivate the chemical dispensing and record and send out a report.

The system may provide data in graphic, visual or textual format, in a manner that translates the necessary system status to the user. The system may give notice that the system is operating or not and the reason such as insufficient data/water supply/electricity/weather conditions to operate. The user may view this information on a phone, electronic tablet, or electronic notebook, on a mobile processing device, a computer, cloud, or on the web. The user can access this system information using computing components such as keyboards, touch pads, monitors, printers, a mouse, etc.

The controller's database administers, organizes, analyzes and processes the data input, location information input, the sensor data, and background information concerning system equipment types, and capabilities, growing area size and chemical identifications. The administration of the irrigation system implements the calendar software to automatically remotely run the irrigation system when parameters indicate. The hardware operates to monitor and actuate values, pumps, on and off systems, and failsafe operations. The controller system 130 translates the data from these sensors and communicates either wireless or directly with the hardware to operate the chemigation system. The controller system 130 has memory characteristics, real time operating system, calendar/task software, sensor data collection, analysis, translation components and background data information system that operates the basic irrigation system by employing the monitored data to send operational control instructions through the system.

In the present embodiment the irrigation system database runs not only the mathematical equations and algorithms needed to operate the water portion of the irrigation system but includes algorithms to automatically calibrate the chemical irrigation portion of the system. The system may also include at least some data in these calculations associated with the irrigation systems water rate or pressure, equipment, chemical information, system operational status, weather conditions, etc. provided to the controller 17. The algorithms within the chemical dispensing calibration software operates on the three principle data components pulled from the data on irrigation systems status, GPS data, chemical flow rate. The processing of this data allows the appropriate injection of chemical to the growing area.

### GPS System

The Global Positioning Satellite (GPS) system to determine and record the positions of transports/boom within the fields, plots within the fields, and chemical application patterns within the field is very important for calculation of accurate dosages of chemical on the growing area. The use of terms such as GPS systems or GPS receivers/transmitters and GPS satellites should be equally applicable to systems which utilize other satellite-based positioning systems. The GLONASS system differs from the GPS system in that the emissions from different satellites are differentiated from one another by utilizing slightly different carrier frequencies, rather than utilizing different pseudorandom codes. GPS indicates the United States Global Positioning System and/or the GLONASS system and other satellite and/or pseudolite-based positioning systems. Pseudolites are ground-or near ground-based transmitters which broadcast a pseudorandom (PRN) code (similar to a GPS signal) modulated on an L-band (or other frequency) carrier signal, generally synchronized with GPS time. Each transmitter may be assigned a unique PRN code so as to permit identification by a remote receiver. The term “satellite”, as used herein, is intended to include pseudolites or equivalents of pseudolites, and the term GPS signals, as used herein, is intended to include GPS-like signals from pseudolites or equivalents of pseudolites.

An irrigation system's transport when equipped with a high-precision GPS transmitter 97 and a controller with a GPS receiver device can result in the development of a digital map of the agricultural field/growing area, and the overlay of where the chemical was applied by chemigation to the field. The map, defined through this operation, should be of sufficient resolution so that the precise location of the transport 90 and the chemical spray coverage area within the growing area can be determined to a few inches with reference to the map. Currently available GPS receivers 107 and transmitters 97, for example like the ProPak.RTM.-V3 produced by NovAtel Inc. (Calgary, Alberta, Canada) or Janus NT-220LT are capable of such operations. The GPS system, or other type of location positioning systems, used in the embodiment transmits the position of the moveable irrigation device 90 in real time, or slight delay of real time via a direct or wireless link with the data receiver within the controller 17. There are other mechanical type location devices that could be employed to provide real time data information, some examples are RFID, manual tripping devices that record location/speed, underground pathway monitoring and reporting systems and the like.

During irrigation operations, the irrigation system have a traveling transport system 90 which operates to move the water conduit and nozzles across the field. The irrigation's transport 90 is fitted with a GPS transmitter 97, and the controller 17 is outfitted with a GPS input receiver 107 which receives transmissions from GPS satellites and the reference transmitter station.

The controller 17 operating on this data may immediately actuate valves, pumps, switches, or time the actuation of this equipment now or in the future. The controller memory and graphics can produce charts and graphs depicting the history, timing and dates of the actuation of the equipment, the GPS information associated with timing of the actuation, the chemical applied, and the weather conditions across activation timing, and the dosage of chemical provided to the crop. This and other information on fertilizer, acid, and chemical irrigation can be provided to the remote user by wireless communication.

Although this chemigation system 10 can operate automatically once the GPS and chemical information is entered and the system can be manually activated; there is also the option for the user to remotely activate, monitor or reprogram the system. The remote user can also provide or change user or sensor information, deactivate one or more sets of input data, switch one or more chemical component identification wherein another or a different chemical is injected into the system or inactivate or reactivate the system.

In operation of one embodiment, the controller of the irrigation system wirelessly transmits and receives information concerning the water flow input, the global positioning information in relation to the speed of the irrigation transport, the injector flow rate input and the chemical identification which triggers information concerning dosage rates. This data, and optionally numerous other inputs, are employed within the mathematical processing system in the controller 17. This data can be initially processed, or alternatively be directly provided for calculation through equation or algorithm(s). The processed data is used to trigger or not trigger valves, switches, and pumps for chemigation of the growing area.

When actuated the equipment begins the introduction of the chemical into the water supply outlet line 30 at an appropriate flow rate for accurate chemical dosage on growing area, without the need for the user to manually calibrate the system. Alternatively, the data can trigger a future task of actuating the chemical introduction, or the data can be placed in memory to be triggered later to provide a control signal to begin chemical actuation, record the event and/or the status of the irrigation system. The embodiment will have a continuous calculation using GPS input and output data in real time. Sensor data which is input such as radiation change, temperature change, soil compaction, soil pH or salinity, field design or topography, respiration/evaporation change, change of water flow rate, change in water or chemical pressure will allow the system to begin, adjust, deactivate or interrupt the introduction of the chemical into the irrigation system 11. Thus, resulting in a proper chemical injection flow rate providing the desired chemical dosage on the growing area. The growing area can be empty of desired plants or seeds, contains desired plants and/or seeds, or contain pests either with or without the desired seeds or plants being present. Desired plants/crops in the growing area can be field crops, like maize, peanuts, sugar beets, soybean, sunflowers, rape, cereals flowers, vegetables, fruits, nuts ornamental crops such as turf, landscapes, and production sites for container grown plants and the like.

The flow chart in table 1 shows the basic process for operation of this continuously calibrating embodiment of the chemigation system.

In other words, the following basic method of operation is used to produce a consistent accurate dosage of chemical in a chemigation system. The chemical product rate input for fields of this type of crop is entered either directly on the control panel 7 or by remote device. The precise GPS location information is provided to the GPS receiver 197 or irrigation device input to the controller system 130 along with any other desired parameters. The system 130 utilizes the software algorithm(s) in the controller's computer to calculate the required chemical flow rate based on continuous GPS enabled speed information. The exchange of GPS location/speed information with the computer allows a real time continuous calculation of the chemical flow rate to maintain accurate dosage. The controller 17 actuates hardware which controls either the chemical injection pump speed or a flow valve on the output side of the injection pump 45 to automatically maintain the precise accurate dosage of chemical. The chemical flow rate can be continuously adjusted by the controller 17 or adjusted in timing intervals as it reruns the updated data through the controller system 130 to provide accurate adjustments to the valves, pumps, and/or flow meters to introduce the exact amounts of chemical at specified timing into the water pipe to provide the desired spray coverage on the growing area. Steps 2 and 3 cycle until the chemigation interval are completed or terminated by automatic failsafe controls or operator input (local or remote). The controller 17 records the transport's 90 location/speed of travel, the rate at which the chemical is actually applied to the growing area and when the chemical application is halted or disrupted in the field/growing area and general spray coverage and chemistry information and maps or graphic visuals of this information.

### Mobile Unit

In embodiments of the present invention, the chemical device system 100 and the controller device 130 may be placed on a mobile unit to connect to an existing water supply device 11 and irrigation device 90. For example, in some embodiments, chemical device system 100, and the controller device 130, may be located in a mobile trailer or other mobile unit, such that it may be transported where chemigation is required. By utilizing such mobile unit, the chemical tank(s) 60 may be filled elsewhere, for example, at a distributor, and then transported such that filling is not required at the actual field site. In addition, one fill of the chemical tank(s) 60 and the mobile aspect of the chemical device system 100 may allow for a user to connect to multiple field locations with existing irrigation device(s) 97 and water supplies without having the fill the chemical tank(s) 60 at each location.

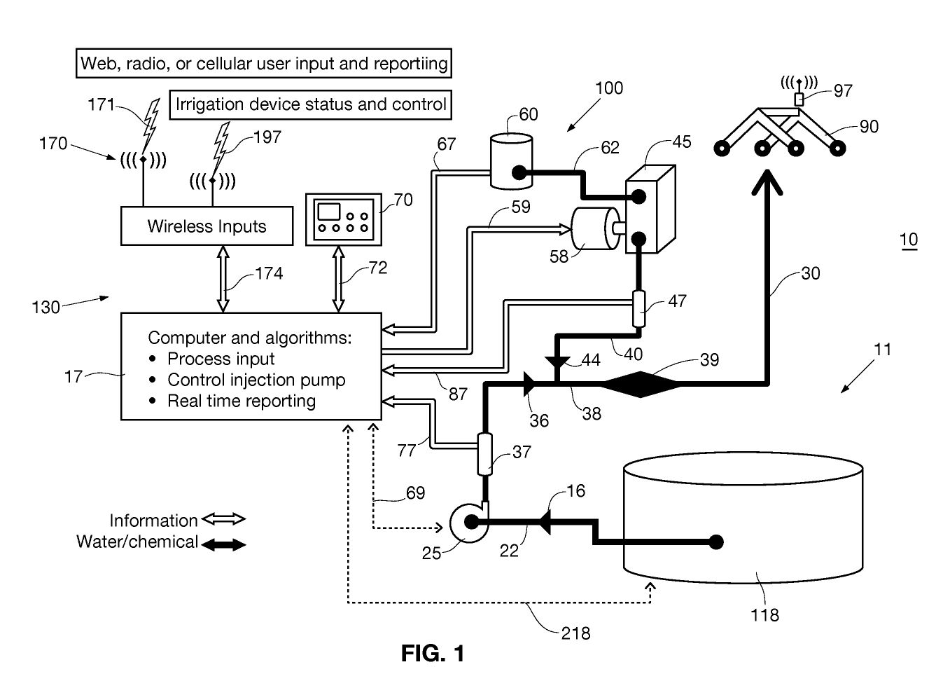

In such a system with mobile units, like that described and shown in FIG. 1, the mobile device may still connect to the water flow meter 37 of an existing water supply device 11 and communicate with the GPS signal device 97 of the irrigation device(s). In addition, the chemical outlet line 40 may connect to the water line 22, such that mixing may take place prior to application into the system and applied by the irrigation device 90.

1. In combination: an irrigation system, including components thereof, for irrigating a growing area comprising a water supply for supplying water to the water delivery portion of the irrigation system, a controller; inputs from at least one water supply sensor and at least one speed sensor correlated to the movement of the water delivery system relative to the growing area; said controller being operatively connected to receive data from said sensors and operatively connected to said irrigation system for controlling the accurate dosage of the active ingredient thereof into the irrigation system for irrigating said growing area wherein said controller accurately provides chemical dosage to the growing area without manual calibration of the irrigation system components.

2. The combination of claim 1 wherein said controller is connected to a weather station which provides weather data to said controller.

3. The combination of claim 1 wherein said controller includes user-defined soil moisture needs.

4. The combination of claim 2 wherein said controller includes user-defined water needs.

5. The combination of claim 1 wherein said controller is connected to equipment associated with said irrigation system for controlling the operation thereof based on the requirements of said irrigation system.

6.-13. (canceled)

14. Apparatus for controlling the application rate of a composition through an irrigation system, comprising:
(a) an irrigation water source;
(b) a pump for supplying irrigation water from said irrigation water source to the irrigation system at a monitored flow rate;
(c) a source of the composition;
(d) a pump for supplying the composition from the source to the irrigation system at a monitored and adjustable flow rate; and
(e) a digital controller operatively connected to said composition pump and receiving inputs corresponding to the flow rate of said irrigation water and the flow rate of said composition to adjust the speed of said composition pump to provide a selected application rate of said composition through the irrigation system.

15. Apparatus for controlling the application rate of a composition to a growing area through a traveling irrigation device, comprising:
(a) an irrigation water source;
(b) a pump for supplying irrigation water from said irrigation water source to the traveling irrigation device at a monitored flow rate;
(c) a source of the composition;
(d) a pump for supplying the composition from the source to the traveling irrigation device at a monitored and adjustable flow rate;
(e) a position monitor for tracking the position of the traveling irrigation device; and
(f) a digital controller operatively connected to said composition pump and receiving inputs corresponding to the location of the traveling irrigation device, the flow rate of said irrigation water, and the flow rate of said composition to adjust the speed of said composition pump to provide a selected application rate of said composition to the growing area.

16.-17. (canceled)
